(19) United States
(12) Patent Application Publication
(10) Pub. No.: US 2013/0311096 A1
(43) Pub. Date: Nov. 21, 2013

(54) Application of engineering principles in measurement of formation gases for the purpose of acquiring more consistent, standardized and authentic gas values for surface logging while drilling

(71) Applicants: Carl Thomas Greer, Houston, TX (US); Rodney Hayes Neumann, The Woodlands, TX (US)

(72) Inventors: Carl Thomas Greer, Houston, TX (US); Rodney Hayes Neumann, The Woodlands, TX (US)

(21) Appl. No.: 13/476,658

(22) Filed: May 21, 2012

(51) Int. Cl. G01N 30/00; G06F 19/00; E21B 21/08

(52) U.S. Cl. 702/9; 175/48

(57) ABSTRACT

A new approach to measuring the gases present in the drilling fluid, or “mud”, while drilling oil and gas wells and analyzing the mud at the well surface. The method replaces inconsistent legacy measurements which mix the formation gases with air arbitrarily and report inconsequential values called “units, Equivalent Methane in Air.” This method instead expresses gas values in terms of Volume of Gas Per Volume of Mud, producing values of universal meaning that everyone can standardize upon. The method further improves gas measurement by expressing gas content using the several energy values of the gases. The resulting standard is a summation measurement of the energy of all gas components present, not limited to Methane. The end result is a gas concentration value that is made universally consistent across many logs made at different times in any location or formation.

### FIELD

Certain embodiments of the present disclosure generally relate to a method and apparatus for generating and logging well data and, more particularly, to an improved method and apparatus enabling efficient, accurate and rapid analysis of a well. The present disclosure presents new methods to extensively improve the legacy methods historically referred to as “mud logging.”

### BACKGROUND

In oil and gas exploration it is important to produce logs of each well in order that the oil/gas producer can determine the geological characteristics and identify the potential productive zones. Due to the expense of the over-all drilling operation, an accurate well log produced while drilling, becomes very beneficial. While down hole, wire-line logs are more definitive, they cannot be used in horizontal holes. Logging methods termed “Measurement While Drilling” and “Logging While Drilling” have limitations requiring the supplementing data furnished by the present disclosure.

To accurately log a well while drilling, it is necessary to acquire accurate compositional analysis data. Accuracy of analysis while drilling progresses also requires speed of analysis. That is, it is necessary to accurately correlate the formation and/or reservoir characteristics of a well and the identified gases present in the drilling fluid with the corresponding depth as those depths are being penetrated and strata is pumped to the surface. Introducing representative samples into an analysis system is important in providing accurate compositional analysis data.

A drilling fluid inlet system that transmits the same distribution of constituents for analysis as were originally present at the wellhead is important.

### SUMMARY

Certain embodiments provide a method for automatically logging a well while drilling. The methods generally include collecting a sample of a known volume of drilling fluid in a gas extractor from a drilling fluid return line, where the drilling fluid return line is in fluid communication with a well. The methods may also include determining a volume and an identity of components of entrained gas from the sample with a gas chromatographic system where the gas chromatographic system is in fluid communications with the gas extractor. The methods may also include calculating a volume for the components of entrained gas per unit volume of the sample and recording the volume of the components of entrained gas per unit volume of the sample correlated to a well depth origin of the sample. The methods may also include generating a graphical representation comprising a recording of the volume of the components of entrained gas per unit volume of the sample correlated to a well depth origin of the sample. The methods may also include calculating an energy content of entrained gas per unit volume of drilling fluid for the main drilling fluid flow based on the product of the volume of each component of the entrained gas per unit volume of drilling fluid and an energy density value for the that component of the entrained gas where the energy per volume of drilling fluid is expressed in British Thermal Units (BTU) per cubic foot. The methods may also include recording the volume of the components of entrained gas correlated to a well depth origin of the sample comprises storing the volume of the components of entrained gas in memory found within a digital logging apparatus. The methods may also include determining a volume and an identity of components of entrained gas from the sample with a gas chromatographic system at a rate of at least once per 30 seconds, where the gas chromatographic system may comprise two or more chromatographs. The methods may also include measuring and adjusting a rate of flow of the drilling fluid into the extractor and measuring and adjusting an air +gas mixture flow from the extractor to the gas chromatographic system.

Certain embodiments provide a digital well logging system. The system generally includes a gas extractor to collect a sample of a known volume of drilling fluid from a main drilling fluid return line, where the main drilling fluid return line is in fluid communication with a well, a surface recording system in fluid communication with the gas extractor comprising a gas chromatographic system configured for determining a volume and an identity of some components of entrained gas from the sample at a frequency of at least once each 30 seconds, a digital logging apparatus, configured to execute a real time logging software program for correlating a depth of a drill within the well to the sample and for calculating a volume for components of entrained gas per unit volume of the sample where the digital logging apparatus is further configured for recording the volume of the components of entrained gas per unit volume of the sample correlated to a well depth origin of the sample and an information management device configured for generating a graphical representation comprising a recording of the volume of the components of entrained gas per unit volume of the sample correlated to a well depth origin of the sample, where the information management device is electrically coupled to the digital logging apparatus. The digital logging apparatus may be configured to determine a lag depth based on a number of pump strokes completed by the pump. The gas chromatographic system may comprise two or more chromatographs. The gas extractor may be configured to regulate a flow of drilling fluid used to collect the sample and further configured to regulate an air+gas mixture flow from the extractor to the gas chromatographic system. The information management device may be further configured for calculating an energy content of entrained gas per unit volume of drilling fluid for the main drilling fluid flow based on the product of the volume of each component of the entrained gas per unit volume of drilling fluid and a nominal energy value for that component of the entrained gas. The information management device may be configured for calculating energy content of entrained gas per volume of drilling fluid for the main drilling fluid flow in British Thermal Units (BTU) per cubic foot.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an exemplary drilling system.

FIG. 2 illustrates a surface recording system coupled to a pump located between the well annulus and the fluid tank.

FIG. 3 illustrates a surface recording system in accordance with embodiments of the present disclosure.

FIG. 4 illustrates an exemplary digital logging apparatus in accordance with embodiments of the present disclosure.

FIG. 5 illustrates example operations for extracting, analyzing, recording, and reporting gas entrained in the drilling fluid while drilling oil and gas wells, in accordance with embodiments of the present disclosure.

FIG. 6 illustrates an exemplary graphical representation of the gas composition and energy content correlated to the originating depth relative to the drilling fluid samples.

### DETAILED DESCRIPTION

Well logs are measurements, typically with respect to depth, of selected physical parameters of earth formations penetrated by a wellbore. Embodiments of the present disclosure generate well logs by measuring qualitative and quantitative characteristics of drilling fluid at the surface and correlating those characteristics to the drilling fluid's originating depth.

Well logs are typically presented in a graphic form including a plurality of grids or “tracks” each of which is scaled from a selected lower value to a selected upper value for each measurement type presented in the particular track. A “depth track” or scale, which indicates depth in the wellbore, is typically positioned between two of the tracks. Depending on the needs of the particular user, any number of or type of measurements may be presented in one or more of the tracks. A typical well log presentation of an individual measurement is in the form of a substantially continuous curve or trace. Curves are interpolated from discrete measurement values stored with respect to time and/or depth in a computer or computer-readable storage medium. Other presentations include gray scale or color scale interpolations of selected measurement types to produce the equivalent of a visual image of the wellbore wall. Such “image” presentations have proven useful in certain types of geologic analysis.

Interpreting well log data includes correlation or other use of a very large amount of ancillary information. Such ancillary information includes the geographic location of the wellbore, geologic and well log information from adjacent wellbores, and a priori geological/petrophysical knowledge about the formations. Other information includes the types of instruments used, their mechanical configuration and records relating to their calibration and maintenance. Other information of use in interpreting well log data includes data about the progress of the drilling of the wellbore, the type of drilling fluid used in the wellbore, and environmental corrections applicable to the particular log instruments used.

Much of this ancillary information may be made available from the wellbore operator (typically an oil and gas producing entity). Examples of this type of information may include the geographic location of the wellbore and any information from other wellbores in the vicinity. Still other types of ancillary information may include records of initial and periodic calibration and maintenance of the particular instruments used in a particular wellbore. The foregoing is only a small subset of the types of ancillary information, which may be used in interpreting a particular well log.

### An Examplary Digital Well Logging System

In the following, reference is made to embodiments of the present disclosure. However, it should be understood that the present disclosure is not limited to specific described embodiments. Instead, any combination of the following features and elements, whether related to different embodiments or not, is contemplated to implement and practice the present disclosure. Furthermore, in various embodiments the disclosure provides numerous advantages over the prior art. However, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the present disclosure” shall not be construed as a generalization of any inventive subject matter disclosed herein and shall not be considered to be an element or limitation of the appended claims except where explicitly recited in a claim(s).

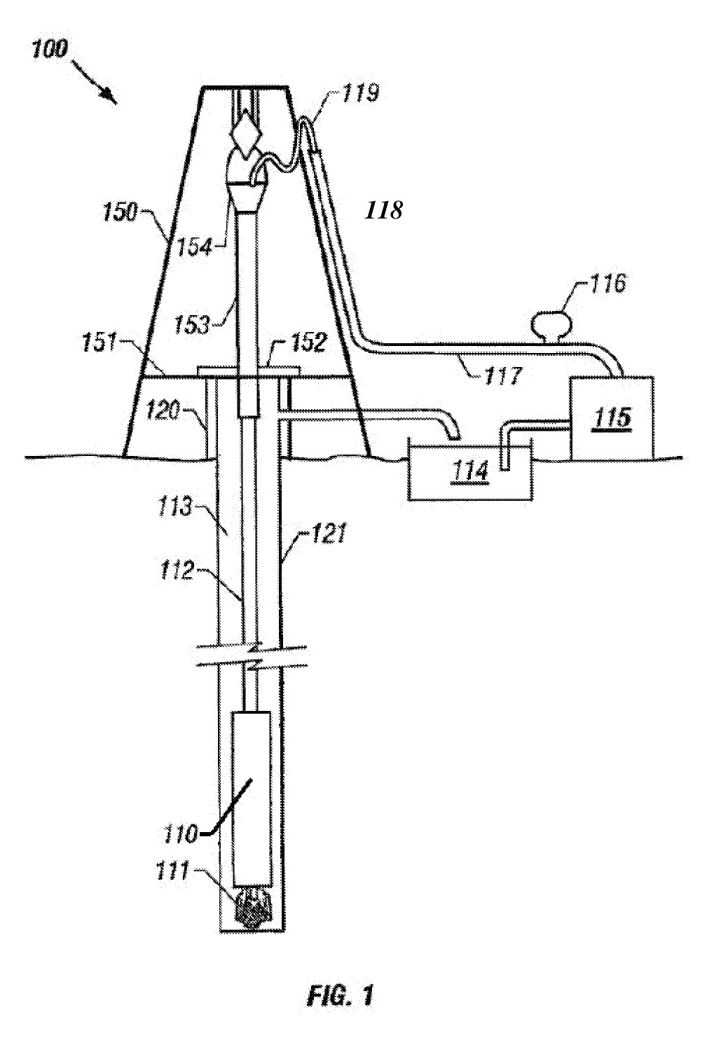

FIG. 1 illustrates an exemplary drilling system. As shown in FIG. 1, the drilling system 100 includes a drill string 112 hanging from a derrick or rig 150. The drill string 112 extends through a rotary table 152 on the rig floor 151 into the wellbore 121. A drill bit 111 is attached to the end of the drill string 112. Drilling is accomplished by rotating the drill bit 111 while some of the weight of the drill string 112 is applied to the bit. The drill bit 111 may be rotated by rotating the entire drill string 112 from the surface using the rotary table 152 which is adapted to drive a kelly 153, or alternatively by using a top drive (not shown). Alternatively, by operating a positive displacement motor known as a “mud motor” 110 disposed in the drill string 112 above the drill bit 111, drilling can be accomplished without rotating the entire drill string 112.

While drilling, drilling fluid is pumped by fluid pumps 115 on the surface through surface piping 117, standpipe 118, rotary hose 119 and swivel 154, kelly 153, and down a hollow central cavity of the drill string 112. Pulsation dampeners 116, also known as desurgers or accumulators, may be located near the outputs of the fluid pumps 115 to smooth pressure transients in the fluid discharged from the fluid pumps 115. The fluid in the drill string 112 is forced out through jet nozzles (not shown) in the cutting face of the drill bit 111. The fluid is returned to the surface through an annular space (i.e., the well annulus 113) between the well bore 121 and the drill string 112.

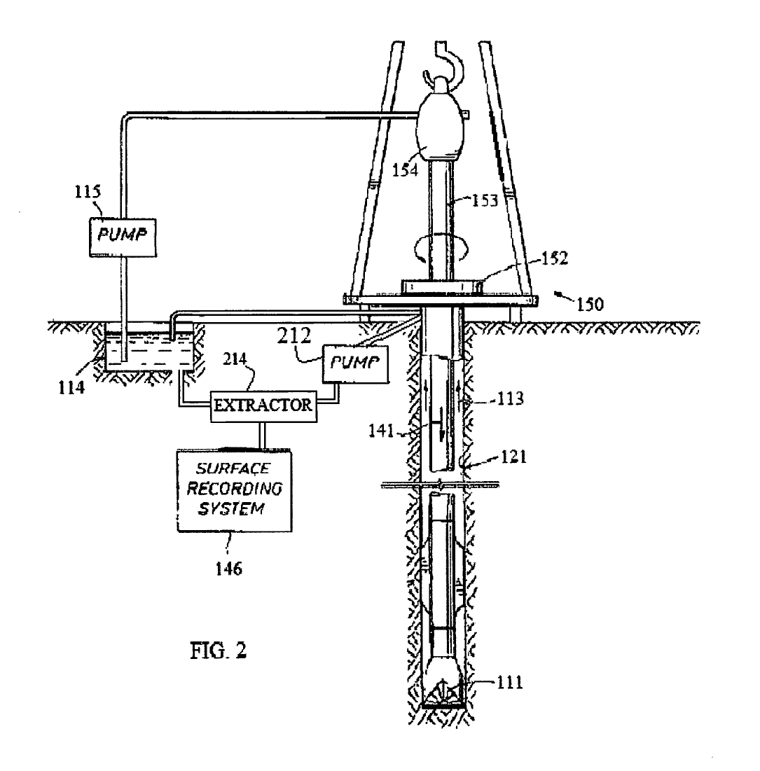

FIG. 2 illustrates a surface recording system 146 coupled to a pump 212 located between the well annulus 113 and the fluid tank 114.

In embodiments of the present disclosure, the methods may include extracting, analyzing, recording, and reporting entrained gas from the drilling fluid while drilling. Specifically, certain embodiments of the present disclosure allow for extracting entrained gas from a controlled volumetric portion of the drilling fluid arriving to the surface through the well annulus 113. After the fluid passes through orifices (not shown) in the bit 111 to lubricate and cool the bit 111, the fluid flows up the well annulus 113 lifting drill cuttings and entrained gas to the surface. A portion of the drilling fluid is then diverted from the main flow line through a positive displacement fluid pump 212 feeding the drilling fluid to the extractor 214 at a constant rate establishing constancy of gas volumes for analysis and enabling the establishment of gas volume related to total well fluid flow. In certain embodiments, the pump 212 and the gas extractor 214 are combined into one unit to more efficiently provide constancy of gas volumes. In certain embodiments the gas extractor 214 and pump 212 are located in a convenient position within the total rig flow system, eliminating the fluid diversion.

By utilizing a positive displacement pump 212 between the well annulus 113 and the fluid pit 114 parallel to the main flow line, the flow rate of diverted drilling fluid may be regulated and entrained gas may be extracted (via extractor 214) from a controlled volumetric portion of the drilling fluid. This may also be accomplished by utilizing the combined pump/extractor method where a pump (not shown) is incorporated into the extractor. There, the positive displacement pump would be replaced with any pump delivering drilling fluid (also known as “mud”) to a tank with a motor driven extractor where the extractor's agitator motor would be passing through a fixed volume of mud. From either method a fixed amount of air+gas is extracted for analysis and he flow rate of mud through extractor and the flow rate of air+gas must be known. Consequently, calibrated peak gas values from the gas chromatographs may be obtained and converted to objective, quantifiable well gas values (e.g., well gas values in BTU per cubic foot of mud), instead of relative measurements produced by legacy systems. Additionally, other objective, quantifiable well gas values may also be derived.

In contrast, legacy practices of analyzing entrained drilling fluid gas using a sensor to produce an electrical signal based value traditionally called “units”. This legacy method and others often produce imprecise values having only relative characteristics. For example, “units” may be defined as 50 units or 100 units=1% gas by volume in air. Sometimes when a certain field or area has begun using one or the other, it continues that way for correlation purposes. Moreover, certain oil companies have long associated units values one way or the other. For example, several major oil operators require any mud loggers to use 100 units=1% Methane in air. While other companies have become accustomed to 50 units=1%. These non-standard measurements reflect an inherent problem with gas extraction. In legacy systems the gas extractor generally dilutes the entrained gas because air is used as a carrier for the gas sample to the analyzers, which may some distance from the extractor. In legacy systems, the amount of air mixed with the pure gas may be arbitrary and unmeasured. The ratio of air to gas might be changed from well to well, from day to day or from equipment to equipment.

However, embodiments of the present disclosure provide calibrated, precise gas values measured in established industry standard percentage amounts from gas chromatographs. The percentage values may be converted to BTU/ft³ or other standard energy values and totaled for the total gas value of each reading. Reporting gas values in BTU/ft3 is objective and quantifiable and, unlike the legacy “units”, provides standardization and easily facilitates well-to-well production comparisons. Embodiments of the present disclosure can also convert the BTU gas values into any desirable term of measurement, even expressing them in terms of the old legacy units for correlation with old well logs.

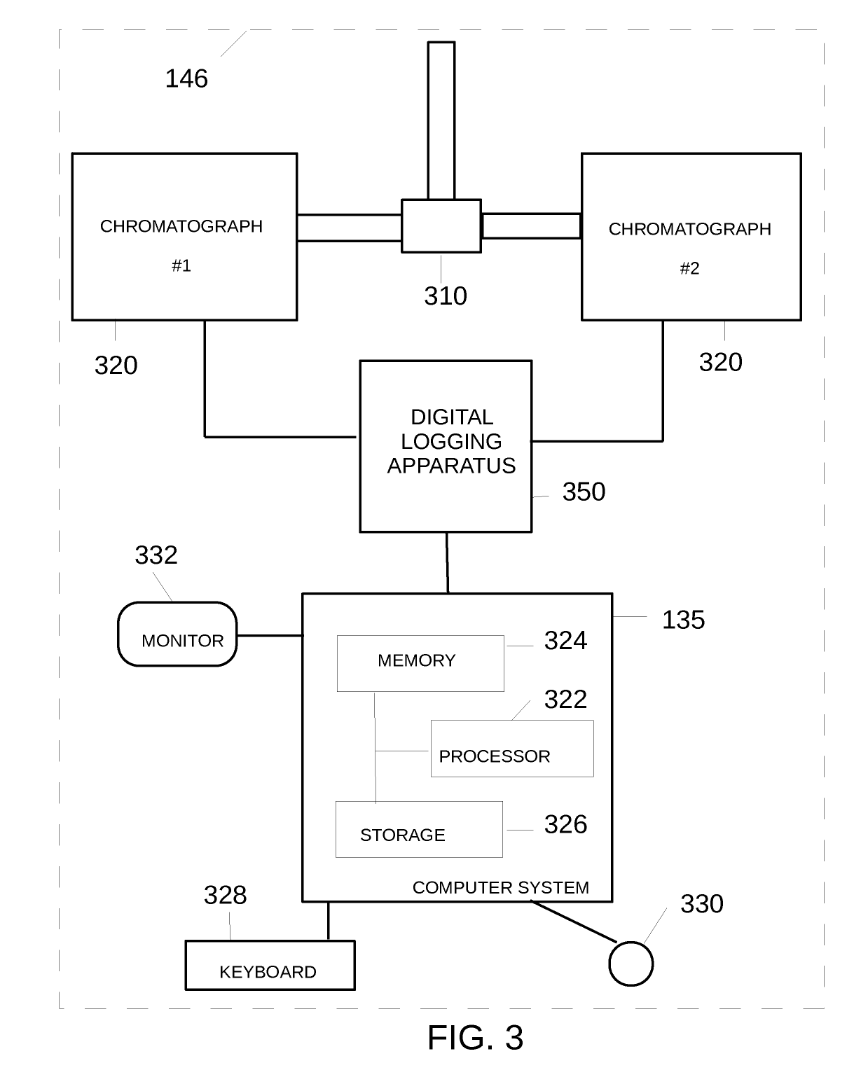

FIG. 3 illustrates a surface recording system 146 in accordance with embodiments of the present disclosure. The surface recording system 146 generally includes two gas chromatographs 320 which provide data relevant to the gaseous composition of a drilling fluid sample to a digital logging apparatus (DLA) 350. In certain embodiments, the digital logging apparatus 350 may be in data communication with a computer system 135.

In traditional embodiments, computer system 135 may be a personal computer (PC); however, any other commonly known computing device may also be used. For example, computer system 135 may be a laptop computer, smart phone, tablet computer, netbook, or any other similar device. Generally speaking, computer system 135 includes a processor 322 in data communication with associated memory 324 and one or more storage devices 326.

The processor 322 may comprise a processor, microprocessor, minicomputer, or any other suitable device, including combinations thereof, for executing programmed instructions, accessing memory, and manipulating data. The processor 322 may also comprise a plurality of such processors, microprocessors, minicomputers, and other such devices. As previously stated, the processor 322 may be in data communication over a local bus interface with the one or more storage devices 326 and memory 324.

The memory 324, as illustrated in FIG. 3, includes non-volatile memory having a firmware program optionally stored therein, such as an initialization start-up program. The non-volatile memory includes, but is not limited to flash memory and electrically erasable programmable read-only memory (EEPROM). The firmware program may contain all the programming instructions required to communicate with a keyboard 328, a display monitor 332, a mouse 330, a DLA 350, other input/output devices not shown here, and a number of miscellaneous functions and/or devices. The memory 324 may also comprise a random access memory (RAM). The operating system (OS) and application programs may be loaded into RAM for execution.

A storage device 326 may be used to store the OS, application programs, and other data for use by the computer system 135. The storage device 326 refers to non-volatile storage devices including permanent and semi-permanent storage devices. The storage device 326 may include, but is not limited to, a hard disk drive (HDD) and a magnetic tape drive. In addition, mobile storage devices may interface with a local bus for transferring data to and from the computer system 135. Examples of mobile storage devices include, but are not limited to, an external portable hard drive; a solid state semiconductor storage device, such as flash memory; and an optical storage device, such as a compact disc (CD) and/or a digital video disk (DVD).

The computer system 135 may further comprise a video display adapter, a plurality of input interfaces, a modem/network interface card (NIC), and a plurality of output interfaces. Output interfaces may transmit data to a printer for printing.

As previously described, application programs may be loaded into memory 324 for execution. One such application may include Real Time Logging (RTL) software (SW). The RTL SW enables communication between a user of the surface recording system 146 and the DLA 350 via the computer system 135. At least one of the plurality of previously described computer system 135 input interfaces, enables the DLA 350 to be in data communication with the computer system 135.

FIG. 3 further illustrates an embodiment of the present disclosure which acquires gas values from the drilling fluid entrained gas using two gas chromatographs 320. In such embodiments, gas extracted from the drilling fluid via extractor 214 may be diverted to each of the gas chromatographs 320 in an alternating fashion by means of an actuator control valve 310. By utilizing two gas chromatographs, a second gas measurement may be taken prior to the completion of (e.g., half way through) the processing and analysis of a first gas sample. The processing and analysis of gas entrained in a drilling fluid sample can take a noticeable period. In some instances, processing and analysis time may reach several seconds per sample. By employing two gas chromatographs 320 the frequency of gas sampling may be increased, reducing the period between samples, thereby allowing data points to be gathered as often as every 10 seconds.

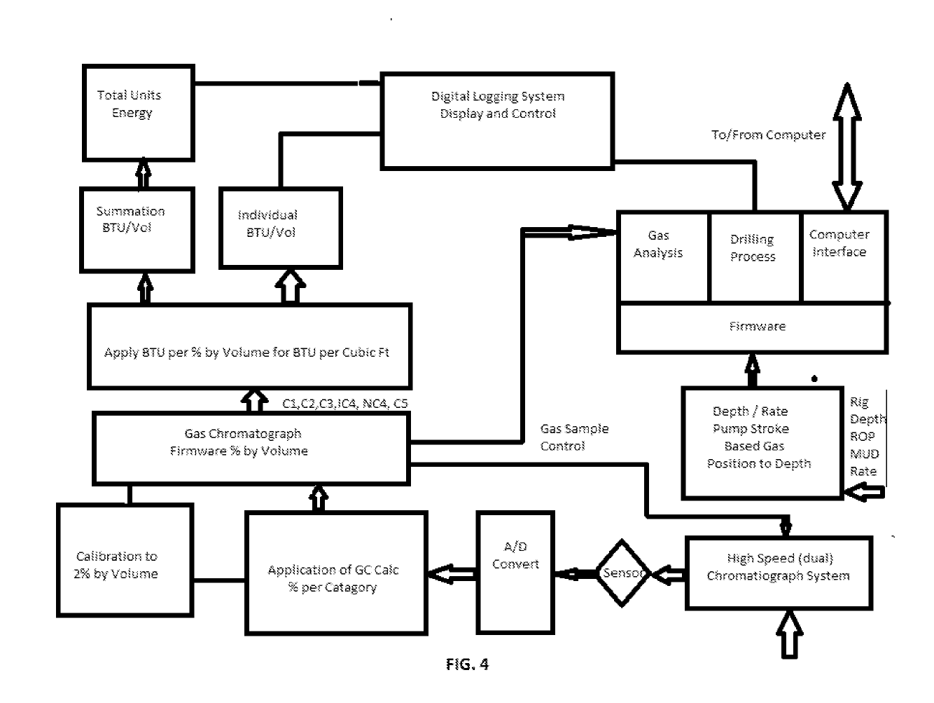

FIG. 4 illustrates an exemplary DLA 350 in accordance with embodiments of the present disclosure. The DLA 350 replaces legacy analog and electromechanical instrumentation and digitizing interfaces by automating the capture of gas component levels and the determination of lag depth and recording historical records of depth and gas composition levels. In embodiments lacking a computer system 135, depth and gas composition levels may be recorded to the memory attached or incorporated within the DLA 350 and later retrieved from the DLA 350 and processed and analyzed independently. In embodiments including a computer system 135, depth and gas composition levels may be communicated to the RTL SW via an input interface. The RTL SW may then record said depth and gas composition levels in storage device 326.

The DLA 350 may monitor, record, and display depth switch contact events and pump stroke switch contact events, calculate and display a rate of penetration (ROP) and pumping rate, display a history of pump stroke counts and pump stroke rates, amplify the electronic signal from catalytic bead or filament gas sensors, capture chromatograph gas sensor signal peak values for each of seven gas components Methane through Pentane, eluting from the chromatograph column, calculate the quantity of gas entrained in a drilling fluid sample, and pass the ROP, pump stroke count, total gas quantity, dilution state, and chromatograph peaks via electronic communications to the computer system 135. Moreover, the DLA 350 may enable users to preset depth counts and pump stroke counts, operate chromatograph pistons, and zero chromatograph gas sensor signals via the DLA front panel.

In addition to replacing legacy analog and electromechanical panels plus communications interface, the DLA 350 automates some manual functions. In legacy systems, the user often manually determined the drilled depth from which the surface evolving drilling fluid originated. In order to accomplish this function, the user had to keep manual lists of pump strokes and depth counts on paper tablets. The delay in presentation to the surface of drilling fluid is due to the transport time lag of the drilling fluid flow from depth of a well to the surface. In legacy systems there is no knowledge of this time lag other than in the form in which it is manually recorded by a user. In those systems, the user must manually determine the transport time lag in terms of pump stokes in contrast to the DLA automatic presentation of the data at its proper depth.

The DLA 350 may automate the storage of depth history, ROP history, gas composition history, and pump stroke history. The storage of depth history, ROP history, gas composition history, and pump stroke history by the DLA 350 further enables an automated searching of the histories for a depth that matches with a given lag time. Consequently, one important component of the DLA 350 is storage or memory modules. Storage modules may be flash (or solid state) storage modules.

The lag time is specified by the user in terms of the quantity of pump strokes that is estimated by the user to represent a volume of drilling fluid. The volume of drilling fluid of interest is the volume of the drilling fluid stream between the drilled depth and the surface. The lag being specified to the DLA 350 is called the lag strokes because it is entered in terms of pump strokes. The DLA 350 takes the lag stroke value and searches the stored histories for records that were previously recorded at a time when the pump strokes being recorded corresponded to the lag strokes.

Moreover, embodiments of the present disclosure may calculate the energy present from gases other than methane. For example, in legacy systems, “units” were based on the percentage of methane to air where 1% methane corresponded to 50 or 100 units. However, embodiments of the present disclosure may analyze, measure, and record the volume and or energy associated with entrained methane, ethane, propane, ibutane, butane, ipentane, pentane, etc.

To accomplish this, embodiments may determine the volume of gas per volume of mud. To determine the volume of gas per volume of mud, firmware of the DLA 350 may calculate values corresponding to the flow rate of mud through the gas trap, Qₘ, the flow rate of air+gas sucked from the trap, Q_{ag}, and the efficiency of the trap, e, (i.e., the ratio of extracted gas volume to the total gas volume entrained within the mud). a sufficiently designed gas extractor will have e=1.0. The rate of flow (Qm) of mud through the extractor and the rate of flow (Qag) of the air+gas mixture into the instruments for analysis must by known and carried into the digital information management instrument in order to continuously calculate the gas present. Both of these rates of flow are equally important for proper use in the formulas to obtain accurate gas content. The Qag drawn off the cannister must also enter the formulas accurately. The technician must determine the optimum amounts of each. For instance, he must have sufficient Qag suction flow to keep the extractor cannister purged to avoid artificial build-up of liberated gases. The mud flow must be sufficient to always have a sample present representative of the main rig mud flow. The technician can easily and quickly measure/set the flow of both by merely placing a bucket to catch the outflow Qm of the extracter and setting the adjustable motor (or pump) to supply the correct amount Likewise the technician can easily and quickly set an adjustable air flow-rater tube off the air circulation pump to control the amount of Qag needed. These desired flows are determined in advance of logging operations and maintained by frequent checking.

The flow rate of mud through the gas trap, Qₘ, may be calculated based on Equation 1, wherein Vₘ is the volume of mud from which gas is extracted and t is the corresponding interval of time.

Qₘ=Vₘ/t Equation 1

The flow rate of gas plus air from the trap, Q_{ag}, may be controlled by the technician, and is based on Equation 2, wherein V_{ag} is the volume of air plus gas and t is the corresponding interval of time.

Qa_{g}=V_{ag}/t Equation 2

The efficiency of the gas extractor, e, may be calculated based on Equation 3, wherein V_{ag} is the volume of air plus gas, Vₘ is the volume of mud from which gas is extracted, Q_{ag} is the flow rate of gas plus air from the trap, and Qₘ is the flow rate of mud through the gas trap.

V_{ag}/Vₘ=e*Q_{ag}/Qₘ Equation 3

Qₘ is known because it is controlled to a fixed rate, and Q_{ag} is known because it is controlled by a flow rate device, both controlled by the technician. Moreover, the efficiency, e, is a function of other factors and can be assumed to be characterized at a specific mud flow rate thereby eliminating flow rate from the function e.

In certain embodiments, the gas sensing analysis may be calibrated in terms of volume of gas per total volume of gas plus air. Calibration consists of pulling in a known volume of pure gas into a syringe, and then pulling in a known volume of air into the syringe. Then if this concentration is made to be 2%, then the gas sensing analysis equipment is calibrated to this value after the zero point is determined using clear air for “zero” in a two point calibration.

When gas sensing analysis is performed on the volume of gas plus air, V_{ag}, the volume of pure gas can be calculated and related to how much mud volume it was extracted from. Given that the gas concentration is measured to be C and C=V_{g}/V_{ag}, or V_{g}=V_{ag}*C. The DLA 350 may determine this volume of pure gas (V_{g}) extracted from a volume of mud, Vₘ.

Having calculated the volume of gas per volume of mud, Vg/Vm, the DLA 350 may determine the Energy per Volume of Mud by multiplying the volume of gas times the nominal energy value for that gas. In certain embodiments, energy may be measured in British Thermal Units (BTU). However, other embodiments may utilize any other standard unit of energy measure.

Since the gas chromatograph separates gas into components: Methane, Ethane, Propane, Butane, Pentane, etc., the energy may be determined by multiplying the volume of a gas by the well known BTU/volume energy value. Moreover, since the volume is determined at approximately standard temperature and pressure (STP) the DLA 350 may use STP constants. As the molecular weight goes up, the energy/volume value tends to go up as well. Table 1 illustrates the standard BTU/ft3 values for the first 5 hydrocarbons of interest, normalized to 1000 for Methane.

TABLE 1

| Methane | Ethane | Propane | iButane | Butane |
|---|---|---|---|---|
| 1000 | 1791 | 2605 | 3160 | 3271 |

So if the volume of gas, V_{g}, is known for the Methane component, as described above, the value V_{g} may be multiplied by 1000 BTU to give the BTU energy value for that volume of Methane.

Similarly, a volume of air plus gas, V_{ag}, may have concentrations of Methane, Ethane, Propane, and isoButane. The gas chromatograph may provide the concentration values Cₘₑₜₕₐₙₑ, Cₑₜₕₐₙₑ, Cₚᵣₒₚₐₙₑ, C_{ibutane}, and the volume of each constituent gas be calculated based on Equation 4, shown below.

V_{constiuent gas}=V_{ag}*C_{constituent gas} Equation 4

Subsequently, the DLA 350 may determine the total BTU, assuming volumes are given in cubic feet (ft³), based on Equation 5.

TotalBTU=(1000*Vₘₑₜₕₐₙₑ)+(1791*Vₑₜₕₐₙₑ)+(2605*Vₚᵣₒₚₐₙₑ)+(3160*V_{ibutane}) Equation 5

Additionally, certain embodiments may also be configured to include hydrocarbons with higher molecular weights (e.g., Pentane, Hexane, etc.).

The legacy gas units that are commonly called “units” are related to concentration in percent such that 50 “units” equal 1% Equivalent Methane in Air (EMA). This standard of using EMA means that the gas sensor is calibrated to a measured concentration of Methane. Measurements of combustible hydrocarbon concentrations then will be given according to the characteristic behavior of the sensor and registered in these units. The method of separating gases with the gas chromatograph (GC), where the GC is calibrated to each gas (not just to Methane), then the measurements are more true with respect to the different weights of each gas. Consequently, when the energy value for each gas is accumulated into a sum of energy, not only is the sensor's behavior characteristic factored out, but the relative energy is also factored in. The improved total gas reading is then traceable to calibration of each alkane component and to energy weight for each alkane component, and the measurements are traceable back to how much volume of mud the gas came from.

Notwithstanding the benefits previously described, embodiments of the present disclosure may provide for the total BTU values to be converted back into terms of legacy “units” for users who want to see it that way.

First, the DLA 350 may calculate the volume of total gas as if it were all Methane by dividing the total BTU value by the energy/volume value associated with methane (i.e., 1000 BTU). The resultant is now normalized as if the volume of methane that has the same energy as the total volume of the gas combination.

While the DLA 350 now has a volume of gas per volume of mud, Vg/Vm, that value must be converted into a concentration value to provide “units”. To convert the Vg/Vm value to “units”, an effective “dilution” ratio, K, must be determined.

To determine K, the DLA 350 may utilize the employed flow rate of mud, Qm, and flow rate of air plus gas, Qag. For example, Qm may be 1 gallon per 13 seconds and Qag may be 5 ft³/hour, resulting in a dilution ratio, K, of 0.135. This dilution value, K, may be utilized in Equation 6 to determine a percentage of gas. Moreover, since there are 50 “units” per 1% of gas, “units” of gas may be calculated based on Equation 7.

% of gas=K*TotalBTU/1000 BTU Equation 6

Units of gas=50*Percent of gas(normalized to Methane Energy and/ft³ of mud) Equation 7

As an example, the mud flow rate may be determined based on a mud pump 115 running at 100 strokes/minute with a displacement of 1 ft³/stroke. Consequently, the mud pump 115 may displace 100 ft³/minute or 6,000 ft³/hour of mud through the annulus. Since the DLA 350 has previously calculated the volume of gas/volume of mud and the energy/ft³ of mud, the DLA may simply multiply this number by the mud flow rate to get a gas flow rate.

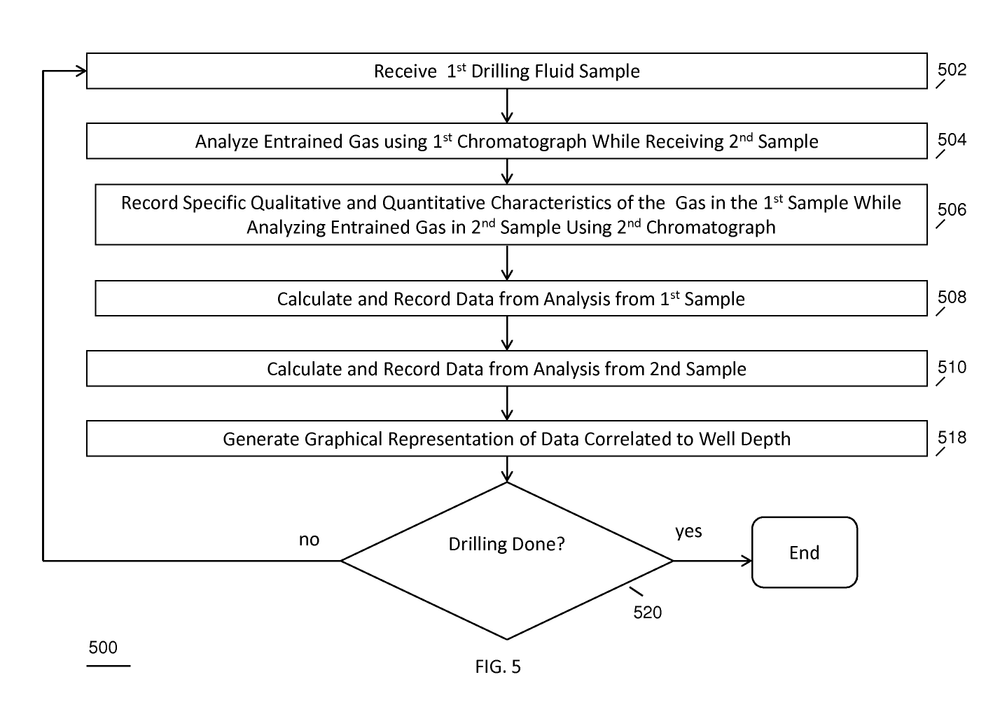

FIG. 5 illustrates exemplary operations 500 for extracting, analyzing, recording, and reporting gas entrained in the drilling fluid while drilling oil and gas wells, in accordance with embodiments of the present disclosure which include the use of multiple chromatographs to achieve near real-time frequency of analysis. This figure can also illustrate embodiments comprising a single high-speed chromatograph system by ignoring the steps for the second chromatograph. In embodiments that use two gas chromatographs, each having two “packed” type columns separating the gases with a catalytic combustion type gas sensor, the sampling valve alternates column to column, separating gases in one while back flushing the other while air carrier gas is circulated. In embodiments that use one GC having two “capillary” type columns separating the gases with a Flame Ionization type gas sensor, the sampling valve alternates column to column, separating gases in one while back flushing the other. Hydrogen carrier gas is circulated.

Exemplary operations 500 begin, at 502, with a surface recording system 146 receiving a first drilling fluid sample at a well surface from a well annulus 113 via a pump 212. In certain embodiments, the pump 212 may be a positive displacement pump. At 504, the surface recording system 146 determines the composition of entrained gas from the first drilling fluid sample with a first chromatograph while a second sample of drilling fluid is acquired by the surface recording system 146 and sent to the second chromatograph for analysis.

At 506, a digital logging apparatus 350 of the surface recording system 146 may receive, calculate and record specific qualitative and quantitative characteristics relative to the first drilling fluid sample while the surface recording system 146 determines the composition of entrained gas from the second drilling fluid sample with a second chromatograph. At 508, the digital logging apparatus 350 receives, calculates and records the composition of entrained gas and the qualitative and quantitative characteristics relative to the second drilling fluid sample.

At 518, the computer system 135 of the surface recording system 146 generates a graphical representation of the composition of entrained gas, the qualitative and quantitative characteristics, and the originating depth relative to each of the drilling fluid samples. At 520, the surface recording system 146 evaluates whether the drilling operations are finished. If the drilling is finished, operations 500 end. However, if drilling is not finished, operations 500 repeat by returning to step 502 and receiving another first drilling fluid sample.

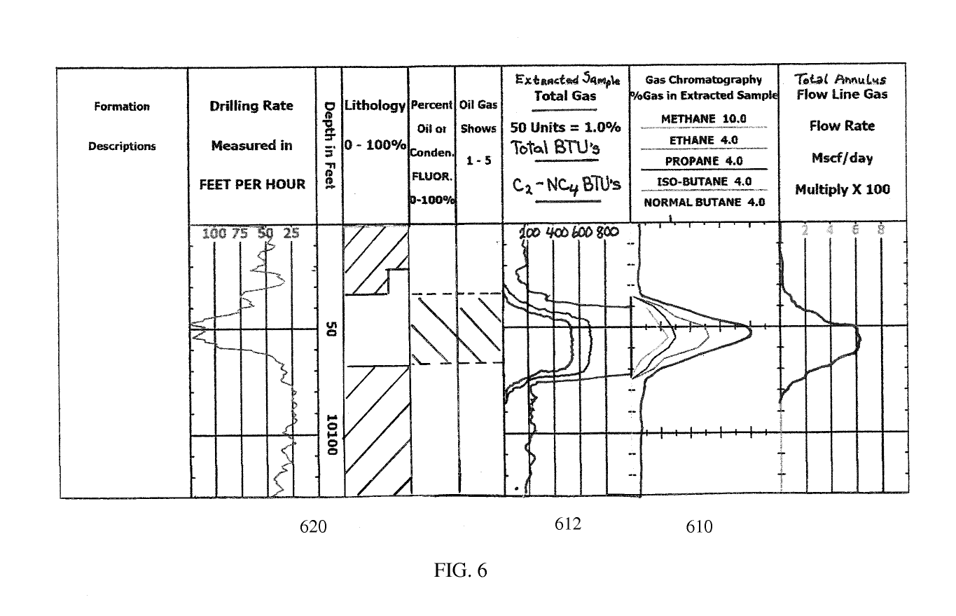

FIG. 6 shows a screen shot of an interactive graphical representation in accordance with one embodiment of the invention. The interactive graphical representation displays results from the computer system 135 calculations such as gas concentration 610 and energy equivalent 612 correlated to well depth 620.

In addition, though not shown in FIG. 6, the customer domain information may also be adjusted via the interactive graphical representation 610. For example, the interactive graphical representation 610 may allow the customer to manipulate the customer domain information via, a textbox, a log display with graphical selection using a line selector overlaying a relationship curve (e.g., a water resistivity curve), a log display with a graphical selection using a line selector overlaying a distribution (e.g., a T2 distribution), a thickness cross plot with graphical selection using a line selector overlaying a cross plot of interest (e.g., porosity versus net pay sensitivity cross plot), etc.

Further, the interactive graphical representation 610 may allow the customer to manipulate the customer domain information for specific zones. For example, the interactive graphical representation 610 allows the customer to choose a specific zone or set of zones and for each zone modify the customer domain information independently from other zones. The zones may be correlated to well depth 620.

By maintaining a constant known flow rate of drilling fluid through the gas extractor, the additional quantitative and qualitative gas values, previously described, may be obtained. These gas values provide new and useful gas information to the well operators, including the heretofore unobtainable total well annulus gas flow rate values as drilling progresses.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

1. A method for automatically logging a well while drilling, comprising:
collecting a sample of a known volume of drilling fluid in a gas extractor from a drilling fluid return line, wherein the drilling fluid return line is in fluid communication with a well;
determining a volume and an identity of at least one component of entrained gas from the sample with a gas chromatographic system wherein the gas chromatographic system is in fluid communications with the gas extractor;
calculating a volume for the at least one component of entrained gas per unit volume of the sample;
recording the volume of the at least one component of entrained gas per unit volume of the sample correlated to a well depth origin of the sample; and
generating a graphical representation comprising a recording of the volume of the at least one component of entrained gas per unit volume of the sample correlated to a well depth origin of the sample.

2. The method of claim 1, further comprising calculating an energy content of entrained gas per unit volume of drilling fluid for the main drilling fluid flow based on the product of the volume of the at least one component of the entrained gas per unit volume of drilling fluid and an energy density value for the at least one component of the entrained gas.

3. The method of claim 2, wherein the energy per volume of drilling fluid is expressed in British Thermal Units (BTU) per cubic foot.

4. The method of claim 1, wherein recording the volume of the at least one component of entrained gas correlated to a well depth origin of the sample comprises storing the volume of the at least one component of entrained gas in memory found within a digital logging apparatus.

5. The method of claim 1, wherein determining a volume and an identity of at least one component of entrained gas from the sample with a gas chromatographic system is done at a rate of at least once per 30 seconds.

6. The method of claim 1, wherein the gas chromatographic system comprises two or more chromatographs.

7. The method of claim 1 further comprising measuring and adjusting a rate of flow of the drilling fluid into the extractor and measuring and adjusting an air/gas mixture flow from the extractor to the gas chromatographic system.

8. A digital well logging system, comprising:
a gas extractor to collect a sample of a known volume of drilling fluid from a main drilling fluid return line, wherein the main drilling fluid return line is in fluid communication with a well;
a surface recording system in fluid communication with the gas extractor comprising:
a gas chromatographic system configured for determining a volume and an identity of at least one component of entrained gas from the sample at a frequency of at least once each 30 seconds;
a digital logging apparatus, configured to execute a real time logging software program for correlating a depth of a drill within the well to the sample and for calculating a volume for the at least one component of entrained gas per unit volume of the sample;
said digital logging apparatus further configured for recording the volume of the at least one component of entrained gas per unit volume of the sample correlated to a well depth origin of the sample; and
an information management device, configured for generating a graphical representation comprising a recording of the volume of the at least one component of entrained gas per unit volume of the sample correlated to a well depth origin of the sample, wherein the information management device is electrically coupled to the digital logging apparatus.

9. The digital well logging system of claim 8, wherein the digital logging apparatus is configured to determine a lag depth based on a number of pump strokes completed by the pump.

10. The digital well logging system of claim 8, wherein the gas chromatographic system comprises two or more chromatographs.

11. The digital well logging system of claim 8, wherein the gas extractor is configured to regulate a flow of drilling fluid used to collect the sample and further configured to regulate an air/gas mixture flow from the extractor to the gas chromatographic system.

12. The digital well logging system of claim 8, wherein the information management device is further configured for calculating an energy content of entrained gas per unit volume of drilling fluid for the main drilling fluid flow based on the product of the volume of the at least one component of the entrained gas per unit volume of drilling fluid and a nominal energy value for the at least one component of the entrained gas.

13. The digital well logging system of claim 12, wherein the information management device is configured for calculating energy content of entrained gas per volume of drilling fluid for the main drilling fluid flow in British Thermal Units (BTU) per cubic foot.
